(19) United States
(12) Patent Application Publication
(10) Pub. No.: US 2004/0162873 A1
(43) Pub. Date: Aug. 19, 2004

(54) Method and apparatus of wrapping an existing service

(75) Inventors: Gou Kojima, Yamato (JP); Yutaka Kudo, Yokohama (JP); Yoko Kinugawa, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd.,, Tokyo (JP)

(21) Appl. No.: 10/683,930

(22) Filed: Oct. 10, 2003

(30) Foreign Application Priority Data
Feb. 17, 2003 (JP) 2003-037597

(51) Int. Cl. G06F 15/16

(52) U.S. Cl. 709/203; 709/236

(57) ABSTRACT

In response to a SOAP request message sent from a SOAP client, a SOAP wrapper, by plural HTTP communications with a WWW application server, makes a service provided by the server perform processing. The wrapper creates a SOAP response message according to HTTP response data acquired as a result of processing under the service, and sends the created SOAP message to the SOAP client.

### CROSS-REFERENCE TO RELATED APPLICATIONS

The present application claims priority upon Japanese Patent Application No. 2003-037597 filed on Feb. 17, 2003, which is herein incorporated by reference.

### BACKGROUND OF THE INVENTION

1. Field of the Invention

The present invention relates to a method of wrapping an existing server service, more particularly, to a method and apparatus of wrapping an existing server service in a situation that the existing service is provided to a client via a network by transmission of screen data to be displayed by the client and, when plural screen transitions are needed to allow the client to use the service, they are consolidated into an exchange of different messages.

2. Description of the Related Art

As one type of distributed system which consists of a network and plural systems connected with it, a client-server system is used in a variety of ways. In a client-server system, a specific system (server) provides a service and other systems (clients) use it through the network. This type of client-server system is used in many network system environments including bank ATM systems and WWW (World Wide Web).

For provision of a service in a client-server system, a communication method and a communication message format should be predetermined and agreed between a client and a server. Regarding communication methods and communication message formats, there are several protocols established by standardization organizations. Among these protocols are HTTP (Hyper Text Transfer Protocol) and CORBA (Common Object Request Broker Architecture). If the server and client should use different communication methods and message formats, the server could not provide the client with its service properly.

Programs unprepared for use in a client-server system cannot be used for the practical purposes in the client-server system.

As a solution to the above problem, a technique called “wrapping” has been developed. The wrapping technique adds a special program to an existing service to change the communication method and/or message format, or adds a special program to an existing program which has no communication method nor message format to give it a communication method and a communication message format so that specific clients can use the service or program. As one such example, a method of wrapping an existing program is disclosed in Japanese Patent Application Laid-open Publication No. Hei11-353181.

It is an application wrapping method in which an existing program component created in an existing system is activated under a newly created application program through a network to process a request from a user. The wrapping method is as follows: the new application program extracts an existing program component needed to process a user request, from existing program components; mapping is made between the existing program components and new application program; the order in which the mapped program components are called for processing is determined according to user requests; the program components are called for processing in the determined order; the content of processing is communicated between the new application program and each program component through the Remote Procedure Call; and the user request is processed by activating the corresponding program component created on the existing system under the new application program.

The use of the above wrapping technique can make an existing program available in a client-server architecture or make a server based on a specific communication method/message format available in a different communication method/message format.

However, the conventional wrapping technique as mentioned above has the following problem: it is very complicated for a computer program developer (developer, hereinafter) to make a program for wrapping. In order to develop a wrapping program, it is necessary to search into the specification of a program to be wrapped and the post-wrapping communication method and communication message format for the program, before coding work. In short, development of a wrapping program requires many man-hours.

### SUMMARY OF THE INVENTION

The invention has been made in view of the above circumstances and provides a wrapping method which decreases the number of man-hours required to develop a wrapping program.

Another object of the invention is to support the development of a wrapping program by executing an existing service to collect necessary information for the wrapping program.

More specifically, the invention is intended to enable a developer to develop, without complicated programming and other tasks, a wrapping program which makes a service offered in a communication method/message format called HTTP available to an existing WWW application server in a communication method/message format called SOAP (Simple Object Access Protocol).

In order to solve the above problem, according to one aspect of the invention, in response to a request from a client, by more than one communication, an existing service to be wrapped is made to perform processing and a message is created according to data acquired as a result of processing under the service and sent to the client.

In addition, scenario data to have the existing service do plural processes successively is created according to data acquired as a result of processing under the existing service and wrapping is done according to the scenario data.

According to another aspect of the invention, in a method of making an existing WWW application available as a web service, a SOAP wrapper, which undertakes screen transitions for the WWW application which an ordinary WWW browser would otherwise undertake, is located between a server for the WWW application and a SOAP client program which is to access the web service. The wrapper acquires data necessary for the screen transition from a SOAP request message sent from the SOAP client and undertakes the screen transitions by accessing the WWW application server using the data. It creates a SOAP response message from the data acquired as a result of the screen transitions and sends the SOAP response message back to the requesting SOAP client.

While the conventional method requires input data for each screen transition, the invention consolidates all required input data into one SOAP request message. This means that one SOAP message exchange replaces plural communications which would be required in the conventional method.

The processing sequence which should be followed by the SOAP wrapper for screen transitions is created according to log data on communications between the existing browser and the WWW application server concerned.

In this method, a developer can make an existing WWW application server service available as a web service without complicated programming work. Even if a service as provided by the WWW application server requires plural screen transitions, input of all necessary data can be replaced by one message exchange.

### BRIEF DESCRIPTION OF THE DRAWINGS

The invention will be more particularly described with reference to the accompanying drawings, in which:

FIG. 1 is a functional block diagram showing an embodiment of the invention;

FIG. 2 shows an example of transition of WWW page screens in a service provided by a WWW application server;

FIG. 3 shows an example of a SOAP request message;

FIG. 4 shows an example of a SOAP response message;

FIG. 5 shows an example of a scenario table;

FIG. 6 is a flowchart showing the steps taken by a SOAP wrapper;

FIG. 7 is a functional block diagram showing the functional configuration of an environment for developing a scenario table for a SOAP wrapper; and

FIG. 8 shows an example of input/output log data.

### DETAILED DESCRIPTION OF THE INVENTION

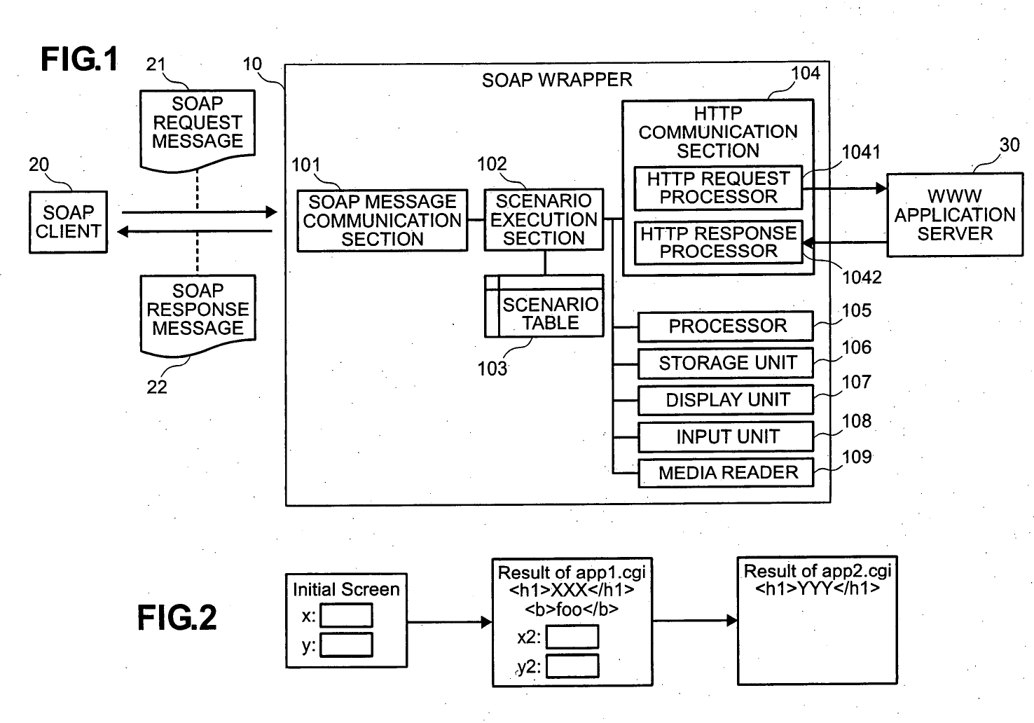

Preferred embodiments of the invention will be described referring to the accompanying drawings. In the functional block diagram shown in FIG. 1, reference numeral 30 represents a WWW application server which provides an application service based on WWW pages. Usually, the WWW application server 30 is a server program which receives an HTTP request message from a WWW client (typically a WWW browser) requesting it to provide a service, performs processing in response to the request, generates WWW pages as a result of processing and sends back an HTTP response message containing the content of the generated WWW pages, to the WWW client.

Numeral 20 represents a client program which usually accesses a web service provided by a SOAP server. This program is called the “SOAP client.”

A web service is one of the techniques to link systems on the Internet. In a network environment in which systems are connected on the Internet using a standard application protocol such as HTTP or SMTP, an upper layer protocol based on an XML (extensible Markup Language) called SOAP (Simple Object Application Protocol) can be used to link the systems by data exchange in the SOAP XML format SOAP is a standard protocol established by the standardization organization W3C (World Wide Web Consortium).

Numeral 10 represents a SOAP wrapper which has the function to convert a service as provided in the HTTP format by the WWW application for use as a web service in a way that the SOAP client can access the service

The SOAP wrapper 10 lies between the SOAP client 20 (which is also a web service client on a network like the Internet) and the WWW application server 30 In order to make the WWW application as provided by the WWW application server 30 available as a web service, in response to a SOAP request message sent from the SOAP client 20, the SOAP wrapper 10 accesses the WWW application with a predetermined access procedure and creates a SOAP response message based on the data acquired by the access and sends back the SOAP response message to the SOAP client

The SOAP wrapper 10 has a processor 105, a storage unit 106, a display unit 107, an input unit 108, and a media reader 109. The storage unit 106 stores an operating system for operation of the SOAP wrapper and various application programs.

The SOAP wrapper 10 is a software module unique to the invention. It also has the following sections: a SOAP message communication section 101 which receives a SOAP request message from the SOAP client 20 and sends a generated SOAP response message back to the SOAP client 20; an HTTP communication section 104 which deals with communications with the WWW application server 30 in the HTTP format; and a scenario execution section 102 which controls the HTTP communication section 104 with a procedure previously specified in a scenario table 103 according to the SOAP request message received by the SOAP message communication section 101 to access the WWW application server 30 and create a SOAP response message 22 to be sent back to the SOAP client 20.

The HTTP communication section 104 has an HTTP request processor 1041 and an HTTP response processor 1042. The HTTP request processor 1041 sends a request message in the HTTP format to the WWW application server 30 and the HTTP response processor 1042 receives a response message in the HTTP format from the WWW application server 30.

The SOAP message communication section 101, scenario execution section 102, and HTTP communication section 104 perform their respective functions when the processor 105 executes the corresponding modular programs. Usually these programs are commercially available on a storage medium like a CD-ROM which is readable by a data processor. The programs are read from the medium by the media reader 109 and stored in the storage unit 106 and thus installed in the SOAP wrapper 10. When the processor 105 reads the programs one after another from the storage unit 106, the above sections perform their respective functions. The scenario table 103 is stored in the storage unit 106 in the same manner as the above programs.

FIG. 2 shows an example of transition of WWW page screens in a service provided by the WWW application server 30.

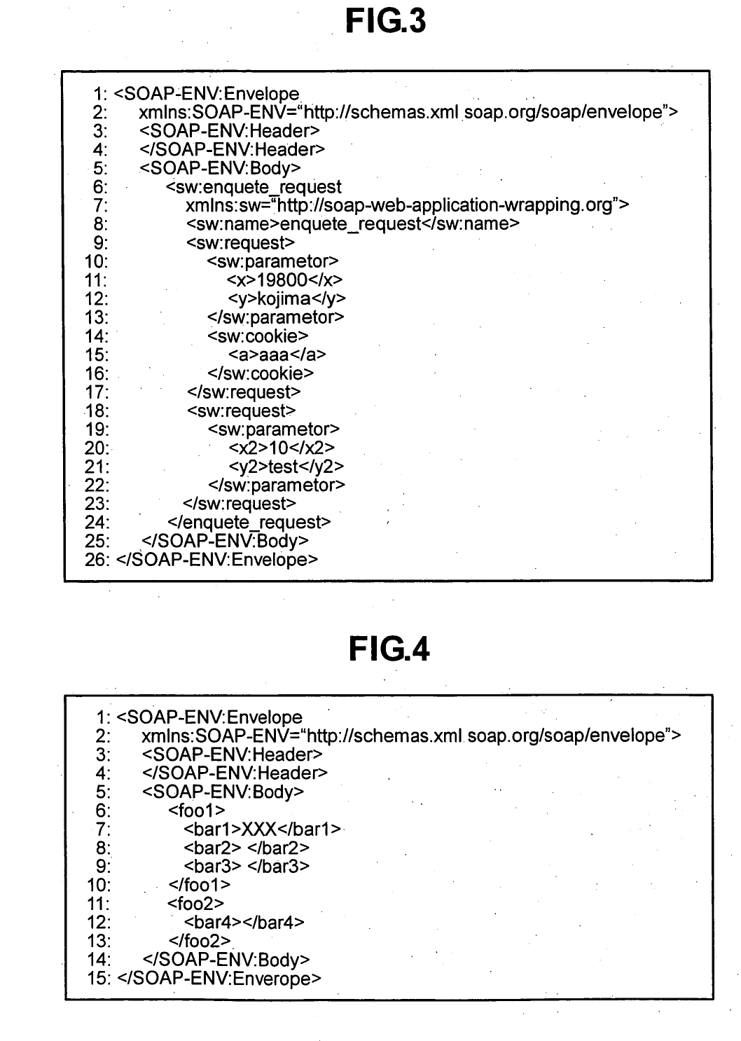

FIG. 3 shows an example of a SOAP request message which is sent from the SOAP client 20 to the SOAP wrapper 10. For convenience in explanation, line numbers are added at the far left.

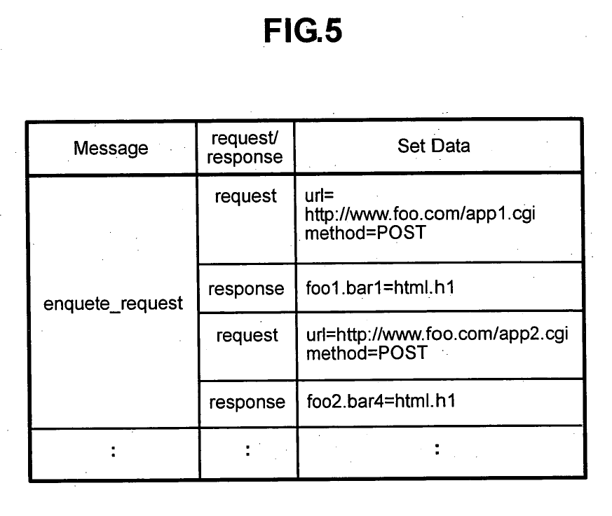

FIG. 4 shows an example of a SOAP response message which is generated by the SOAP wrapper 10 in response to the SOAP request message and sent to the SOAP client 20. For convenience in explanation, line numbers are added at the far left.

FIG. 5 shows an example of the scenario table 103 which the scenario execution section 102 as a program module of the SOAP wrapper references.

In this embodiment, the SOAP wrapper 10 performs processing to make a service as provided by the WWW application server 30 (which involves screen transition as shown in FIG. 2) available as a web service, and provides the SOAP client 20 with the service as a web service available from the WWW application server 30 by exchange of SOAP messages as shown in FIGS. 3 and 4.

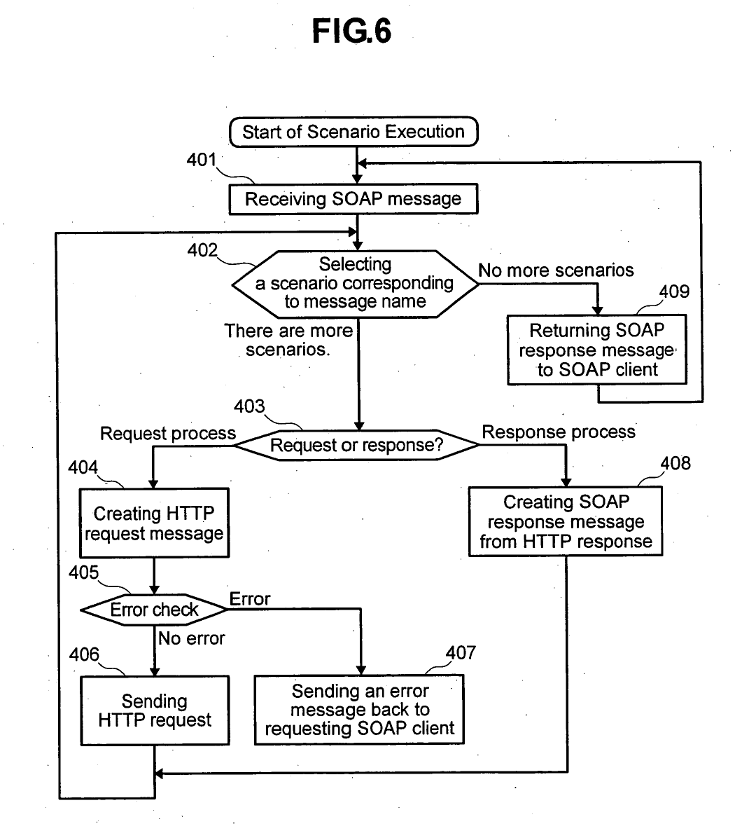

Next, according to the flowchart of FIG. 6, the steps which are taken by the SOAP wrapper 10 will be explained in detail.

The scenario execution section 102 is responsible for control of the whole SOAP wrapping process for a WWW application service provided by the WWW application server 30, which is performed by the SOAP wrapper 10.

As the SOAP message communication section 101 receives a SOAP request message 21 from the SOAP client 20, it sends the message to the scenario execution section 102 (step 401). The scenario execution section 102 references the scenario table 103 and selects the scenario which corresponds to the name of the SOAP request message 21 received from the SOAP message communication section 20 as a scenario to be executed (step 402). The name of the SOAP request message 21 is indicated in the area enclosed by <sw: name> tags in Line 8 in FIG. 3. In the scenario table 103 of FIG. 5, a scenario which corresponds to the SOAP request message with the name “enquete_request” is indicated. The scenario consists of four lines of scenario data. The scenario execution section 102 reads the request/response column and the set data in the lines of the selected scenario from top to bottom line by line and carries out the following procedure according to the data in the lines thus read. After finishing reading all the lines of the scenario, it carries out the process of ending the scenario which will be stated later.

After the scenario execution section 102 reads the data in the lines of the scenario table 103, it first decides whether each line of the request/response column specifies either request or response (step 403).

If a line of the request/response column specifies “request,” the request process as described below is carried out (in the case of the scenario table 103 shown in FIG. 5, the first and third lines of the request/response column specify “request”).

If a line of the request/response column specifies “request,” the scenario execution section 102 acquires the URL of the web application to be accessed in the HTTP format and the relevant access method, from the set data in the line of the scenario table 103 which it is referencing (in the case of the scenario table 103 of FIG. 5, according to the data in the first line, the URL of the web application to be accessed is http://www.foo.com/appl.cgi and the access method is POST). Then, the scenario execution section 102 reads the SOAP request message (FIG. 3) received from the SOAP message communication section 101 and acquires parameter and cookie data for HTTP access. The parameter and cookie data for HTTP access are indicated in the areas enclosed by <sw: request> of Lines 9 to 17 and 18 to 23 in FIG. 3. When carrying out the above request process more than once, the scenario execution section 102 reads and processes more than one <sw: request> which are included in the SOAP request message, from top to bottom one by one.

The parameter data for HTTP access is indicated in the area enclosed by <sw: parameter> tags in Lines 10 to 13 (FIG. 3). The scenario execution section 102 reads the area enclosed by the <sw: parameter> tags to acquire parameter data. Here, the tag name represents the parameter name and the data in the area enclosed by the <sw: parameter> tags represents the data of the parameter identified by the parameter name. The scenario execution section 102 acquires this as the parameter for HTTP access.

The cookie data for HTTP access is indicated in the area enclosed by <sw: cookie> tags in Lines 14 to 16 (FIG. 3). The scenario execution section 102 reads the area enclosed by the <sw: cookie> tags to acquire cookie data. Here, the tag name represents the cookie name and the data in the area enclosed by the <sw: cookie> tags represents the data of the cookie identified by the cookie name. The scenario execution section 102 acquires this as the cookie for HTTP access.

With the above procedure, the scenario execution section 102 acquires the necessary URL, access method, parameter and cookie data for HTTP access. The scenario execution section 102 sends the above necessary data for HTTP access to the HTTP request processor 1041, which in turn uses the necessary data for HTTP access received from the scenario execution section 102 to create an HTTP request message for the WWW application server 30 (step 404).

After the HTTP request processor 1041 creates the HTTP request, the scenario execution section 102 checks whether the request should be sent or not (step 405).

According to the following characteristic of the WWW application, the scenario execution section 102 checks whether to send the HTTP request message or not. First, it checks whether the screen (usually in HTML) already received from the WWW application server 30 in response to the preceding or last HTTP request includes the URL to be accessed next or not; if no, the current HTTP request message is not sent and an error process (stated later) is carried out. On the other hand, if yes, namely the URL to be accessed next is included in the last screen, the current HTTP request message is sent for further processing. If the current HTTP request message is an initial request message, there is no preceding screen and it is immediately sent without taking the above mentioned step of checking whether to send it or not.

After the HTTP request processor 1041 sends the HTTP request message to the WWW application server 30, the HTTP response processor 1042 receives an HTTP response message as a result of processing by the WWW application server 30 and holds the message for use in the next step to be taken by the scenario execution section 102.

When the scenario execution section 102 checks whether to send the HTTP request message or not and decides that the message should not be sent, it sends the SOAP client 20 a SOAP response message through the SOAP message communication section 101 to notify of occurrence of an execution error (step 407).

The scenario execution section 102 ends the whole request process when the HTTP request processor 1041 has sent the HTTP request message; then it proceeds to the process for the next scenario data line.

If the line of the request/response column of the scenario table 103 which is being referenced specifies “response,” the scenario execution section 102 carries out the response process as described below (in the case of the scenario table 103 shown in FIG. 5, the second and fourth lines of the request/response column specifies “response”).

If a line of the request/response column specifies “request,” according to the set data in the line of the scenario table 103 which is being referenced, the scenario execution section 102 acquires data for creation of a SOAP response message to be sent back to the SOAP client 20, from the HTTP response message as a result of processing by the WWW application server 30 which the HTTP response processor 1042 receives through the preceding or last HTTP request process. For example, in the second line of the scenario table 103 of FIG. 5, out of the HTML data included in the HTTP response message acquired as a result of processing from the WWW application server 30, the character string enclosed by the <h1> tags following the <html> tag is set as the character string enclosed by the <bar1> tags enclosed by the <foo1> tags. The scenario execution section 102 creates a SOAP response message 22 from the HTTP response message according to the above data for creation of a SOAP response message (step 408). Even when the above response process is carried out more than once while a scenario is being executed, the scenario execution section 102 acquires plural sets of data from plural HTTP response messages and consolidates the acquired plural sets of data to create one SOAP response message 22 as the final SOAP response message 22 which is sent back to the SOAP client 20 (step 407).

The scenario execution section 102 at the start of the execution: finishes reading all the scenario lines of the scenario table 103 to be executed which it has selected according to the SOAP request message 21 received by the SOAP message communication section 101; it considers the execution of the scenario as being finished, and sends the SOAP response message 22 created during the execution of the scenario, to the SOAP message communication section 101, which in turn sends back the SOAP response message 22 received from the scenario execution section 102 to the requesting SOAP client 20 (step 409).

The SOAP client 20 receives the SOAP response message 22 as a result of processing by the SOAP wrapper 10 of the SOAP request message 21 which it has sent to the SOAP wrapper 10.

According to this embodiment, when the SOAP wrapper 10 and the scenario table 103 matched to the service provided by the WWW application server 30 are used, the service which is available as an WWW application is wrapped in the SOAP format and made available as a web service without the need for modifying the existing WWW application server 30. In addition, regarding a service provided in the form of a WWW application by the WWW application server 30, even when the final result of processing under the service becomes available to a WWW client (WWW browser) after several message exchanges between the WWW application server and the WWW client, the SOAP wrapper 10 exchanges messages with the WWW application server 30 several times on behalf of the WWW client so that the requesting SOAP client can obtain the result of processing under the service as desired just through one SOAP message exchange.

Furthermore, in this embodiment, the scenario 103 matched to the service provided by the WWW application server 30 is created and the scenario execution section 102 carries out the SOAP wrapping process according to the scenario table 103. The apparatus and method of creating a scenario table 103 are described below.

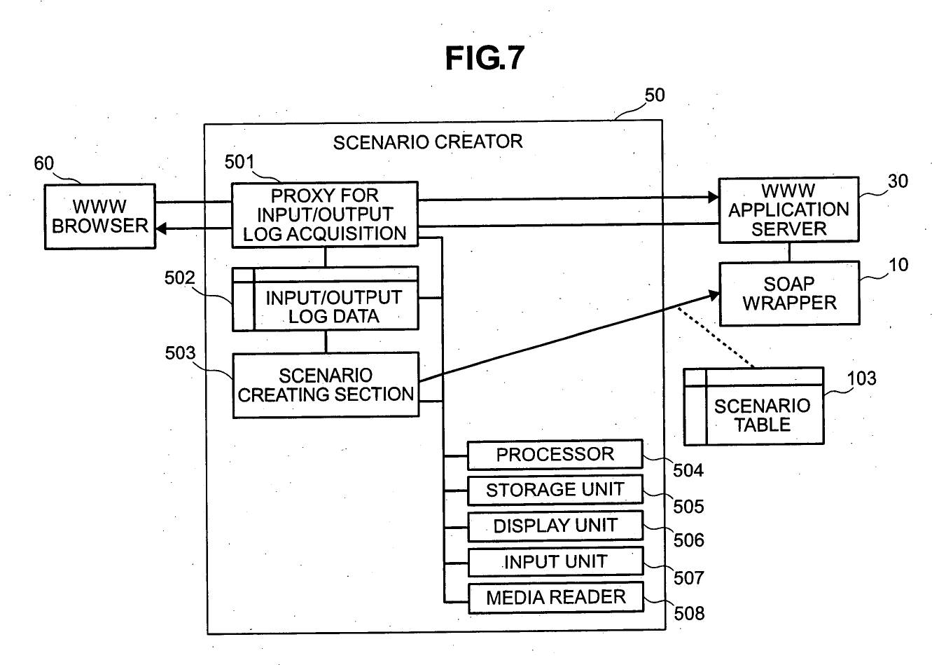

FIG. 7 is a functional block diagram showing an environment in which the scenario table 103 is created.

In FIG. 7, numeral 60 represents a WWW browser as a WWW client which usually accesses the WWW application server 30 and uses a WWW application.

In the figure, numeral 50 represents a scenario creator which acquires a data log of communications between the WWW browser 60 and the WWW application server 30 and creates the scenario table 103 based on the acquired data log.

The scenario creator 50 incorporates a processor 504, a storage unit 505, a display unit 506, an input unit 507, and a media reader 508 where the storage unit 505 stores an operating system under which the scenario creator works, as well as various application programs.

The scenario creator 50 has software modules unique to the invention: a proxy for input/output log acquisition 501 which mediates communications between the WWW browser 60 and WWW application server 30 and acquires data on the communications; and a scenario creating section 503 which references the input/output log data 502 acquired by the proxy for input/output log acquisition 501 and creates a scenario.

The proxy for input/output log acquisition 501 and the scenario creating section 503 perform their respective functions when the processor 504 executes the corresponding modular programs. Usually these programs are commercially available on a storage medium such as a CD-ROM which is readable by data processors. They are read from the medium by the media reader 508 and stored in the storage unit 505 and thus installed in the scenario creator 50. As the processor 504 reads and executes the programs sequentially, the proxy 501 and the scenario creating section 503 perform their functions. The input/output log data 502 is stored in the storage unit 505 in the same manner as the above programs.

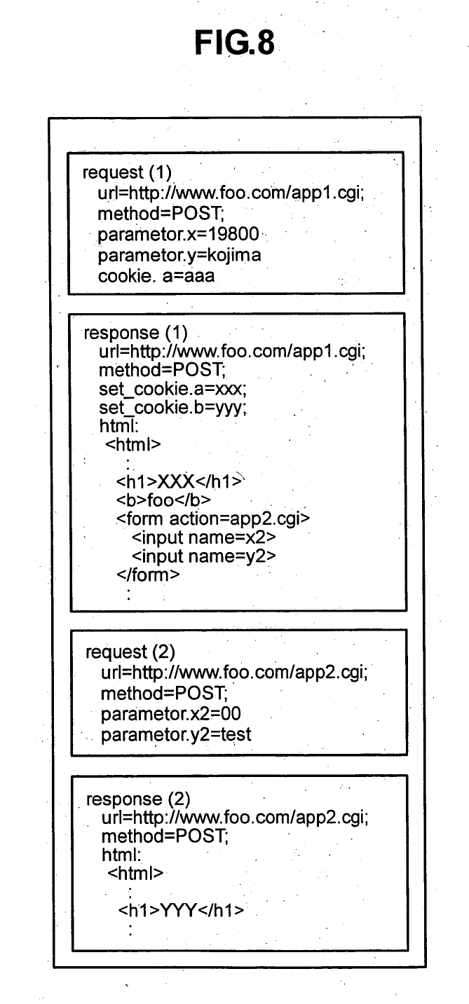

FIG. 8 shows an example of input/output log data on communications between the WWW browser 60 and WWW application server 30, which the proxy for input/output log acquisition 501 acquires. This input/output log data concerns a situation that the WWW browser 60 accesses a service which is provided by the WWW application server 30 (see FIG. 2).

Given below is a detailed explanation of the process in which the scenario creator 50 creates a scenario.

When a developer is going to create a scenario using the scenario creator 50, first of all he/she defines the proxy for input/output log acquisition 501 as an HTTP proxy server for HTTP access by the WWW browser 60.

Here, an HTTP proxy means an intermediary server which is typically used for control of company users' access to the Internet or caching accessed data and gives permission for Internet access to particular users only or accumulates user access log data. According to the invention, the HTTP proxy is used to acquire a log of communications between the WWW browser 60 and the WWW application server 30 which is referenced in creating a scenario.

Next, the developer accesses the WWW application server 30 using the WWW browser 60 in the same manner as usual and uses the application for which a scenario is created. At this time, the proxy for input/output log acquisition 501, which serves as an HTTP proxy for the WWW browser 60, records data on communications between the WWW browser 60 and the WWW application server 30 which take place while the application is being used, as input/output log data 502 (FIG. 8).

As shown in FIG. 8, the input/output log data includes, from top to bottom, the following: a first HTTP request which is made from the WWW browser 60 to the WWW application server 30; a first HTTP response which is made from the WWW application server 30 to the WWW browser 60; a second HTTP request which is made from the WWW browser 60 to the WWW application server 30; and a second HTTP response which is made from the WWW application server 30 to the WWW browser 60.

For example, it can be understood from the log data that in the first HTTP request, the URL to be accessed is “http://www.foo.com/appl.cgi”; the access method is “POST”; the data of parameter x is “19800” and the data of parameter y is “kojima”; and the data of cookie a is “aaa”. Also it is indicated here that in the first HTTP response, the URL to be accessed is “http://www.foo.com/appl.cgi”; the access method is “POST”; the data of cookie a is “xxx”; and the data of cookie b is “yyy”. In addition, the HTML content to be displayed by the WWW browser 60 is shown here.

The scenario creating section 503 reads the input/output log data 502 sequentially and creates a scenario table 103 in a way to match the request/response data. Since the request set data in the scenario table should only include the URL to be accessed and the access method, the scenario creating section 503 makes the set data for request in the scenario table 103 just by referencing the request data in the input/output log data 502.

The set data for response in the scenario table 103 should include data which is required to make a SOAP response message from HTML data included in the HTTP response from the WWW application server 30. The developer of the scenario table references the response data in the input/output log data 502 and enters necessary set data for the SOAP response message, into the scenario creating section 503, so that reference is made to it. The procedure of making the set data is the same as the procedure which the scenario execution section 102 follows (stated earlier).

With the above sequence, the scenario creating section 503 creates the scenario table 103 from the input/output log data 502.

According to this embodiment, using the scenario creator 50, the developer can create the scenario table 103 according to the input/output log data 502 acquired from communications between the WWW browser 60 and the WWW application server 30, without necessitating the developer to do complicated programming work. Also, when the SOAP wrapper 10 which stores the created scenario table 103 is used, an existing service which the WWW application server 30 offers in the form of a WWW application is made available as a web service to a SOAP client by SOAP wrapping the service as it is, or without modifying it.

In the above first embodiment, on a network like the Internet, the SOAP wrapper 10 lies between the SOAP client 20 as a web service client and the WWW application server 30. However, the SOAP wrapper 10 may be implemented as a program on the same computer where the SOAP client resides or as a program on the same computer where the WWW application server 30 resides.

Note that the first embodiment, in setting for response, allows the developer of the scenario table 103 to enter necessary set data into the scenario creating section 503 of the scenario creator 50 thereby to create the scenario table 103 with the scenario creator 50. According to a second embodiment of the invention (described below), this process is replaced by a simpler process in which the developer no longer has to enter necessary set data and instead the scenario creating section 503 automatically creates the scenario table 103.

The second embodiment is different from the first embodiment in the process which the scenario creating section 503 follows. In the second embodiment, the scenario creating section 503 controls the process of creating the scenario table 103 in a way that all the HTML content in the response data of the input/output log data 502 is included in the SOAP response message 22 to be sent back to the SOAP client 20. Consequently, when creating the scenario table 103 using the scenario creator 50, the developer can not only have the scenario creator 50 store the input/output log data 502 through the WWW browser 60 using the service of the WWW application server 30 to which the SOAP wrapper is applied, but also create the scenario table 103 without the need for additional data input to the scenario creating section 503.

However, in the process which is followed by the scenario creator 50 according to the second embodiment, since all HTML data as a result of processing by the WWW application server 30 is included in the SOAP response message 22 which the SOAP wrapper 10 sends back to the SOAP client 20, the SOAP client 20 may have to deal with a higher volume of data after receiving the SOAP response message 22, than in the first embodiment. If it is necessary to reduce the load on the SOAP client 20 after reception of the SOAP response message 22, the process according to the first embodiment should be chosen.

Therefore, according to the invention, when a scenario creator is used, a developer can create a scenario table necessary for wrapping an existing service according to data acquired as a result of processing under the existing service such as input/output log data, without necessitating the developer to do complicated programming work. When wrapping is done according to the created scenario table, the existing service becomes available as a service matched to a new protocol, without the need for modifying the existing service.

What is claimed is:

1. An apparatus of wrapping an existing service comprising:
means for, by plural communications with an existing service to be wrapped, making the existing service perform processing;
means for creating a message for a client according to data acquired as a result of processing under the service; and
means for sending a created message to a client.

2. An apparatus as claimed in claim 1, further comprising:
means for holding scenario data used to allow the existing service to be done, by plural communications with the existing service, according to data acquired as a result of processing under the existing service,
wherein the message creating means creates a message according to the scenario data.

3. An apparatus as claimed in claim 2, wherein the scenario data includes:
a definition which identifies a server providing a service to be accessed and wrapped, based on request data from the client;
a definition which identifies data necessary for access to the service to be wrapped, based on request data from the client; and
a definition which specifies a manner of making a message to be sent back to the client, according to data acquired as a result of processing under the service to be wrapped.

4. An apparatus as claimed in claim 3, wherein the scenario data is created according to log data on communications between the service to be wrapped and a client capable of using the service as it is.

5. A method of wrapping an existing service, which is used in a wrapping apparatus connected with a client device and a server providing an existing service, comprising the steps of:
performing processing under the existing service by plural communications with an existing service to be wrapped;
creating a message for a client according to data acquired as a result of processing under the service; and
sending a created message to a client.

6. A method as claimed in claim 5, further comprising the steps of:
creating scenario data used to allow the existing service to be done, by plural communications with the existing service, according to data acquired as a result of processing under the existing service,
wherein the message creating step creates a message according to the scenario data.

7. A method as claimed in claim 6, wherein the scenario data includes:
a definition which identifies a server providing a service to be accessed and wrapped, based on request data from the client;
a definition which identifies data necessary for access to the service to be wrapped, based on request data from the client; and
a definition which specifies a manner of making a message to be sent back to the client, according to data acquired as a result of processing under the service to be wrapped.

8. A method as claimed in claim 7, wherein the scenario data is created according to log data on communications between the service to be wrapped and a client capable of using the service as it is.

9. A computer-readable medium storing a program for wrapping an existing service, the program comprising the steps of:
making the existing service perform processing, in response to a request from the client, by plural communications with an existing service to be wrapped;
creating a message according to data acquired as a result of processing under the service; and
sending the created message to the client.
